(19) United States
(12) Patent Application Publication
(10) Pub. No.: US 2024/0360703 A1
(43) Pub. Date: Oct. 31, 2024

(54) ELECTRONIC LATCH CONTROL METHOD AND ASSEMBLY

(71) Applicant: Ford Global Technologies, LLC, Dearborn, MI (US)

(72) Inventors: Rajesh K. Patel, Farmington, MI (US); Christopher Matthew Radjewski, Macomb Township, MI (US); Constantin Manolescu, Rochester Hills, MI (US)

(21) Appl. No.: 18/308,780

(22) Filed: Apr. 28, 2023

(51) Int. Cl. E05B 81/14; E05B 81/76; E05B 85/10

(52) U.S. Cl. CPC E05B 81/14; E05B 81/76; E05B 85/10

(57) ABSTRACT

An electronic latch control method includes receiving an unlatch signal from at least one handle switch associated with a closure module of a vehicle, and assessing whether the vehicle is in a wash mode. The method, when in the wash mode, responds to the unlatch signal by maintaining an electronic latch in a latched position to maintain the closure module in a closed position.

### TECHNICAL FIELD

This disclosure relates generally to controlling an electronic latch of a vehicle and, more particularly, to control of the electronic latch when the vehicle is being washed.

### BACKGROUND

Some vehicles include electronic latches that are used to hold closure modules in a closed position. The closure module can be a side door, rear door, tailgate, etc. The electronic latches can transition from a latched position to an unlatched position in response to a release signal.

### SUMMARY

In some aspects, the techniques described herein relate to an electronic latch control method, including: receiving an unlatch signal from at least one handle switch associated with a closure module of a vehicle; assessing whether the vehicle is in a wash mode; and when in the wash mode, responding to the unlatch signal by maintaining an electronic latch in a latched position to maintain the closure module in a closed position.

In some aspects, the techniques described herein relate to a method, further including when not in the wash mode, responding to the unlatch signal by transitioning the electronic latch from the latched position to an unlatched position to permit pivoting of the closure module from the closed position to an open position.

In some aspects, the techniques described herein relate to a method, wherein the unlatched position permits the closure module to pivot about an axis.

In some aspects, the techniques described herein relate to a method, wherein the maintaining includes locking the closure module in the closed position.

In some aspects, the techniques described herein relate to a method, wherein the maintaining includes preventing a transitioning of the electronic latch from the latched position to an unlatched position.

In some aspects, the techniques described herein relate to a method, wherein the wash mode is activated when water is detected, a transmission of the vehicle is in park or neutral, a speed of the vehicle is below a threshold speed, and a brake of the vehicle is disengaged.

In some aspects, the techniques described herein relate to a method, wherein water is detected by at least one sensor of the vehicle.

In some aspects, the techniques described herein relate to a method, wherein the wash mode is activated at least in part based on an input from a user.

In some aspects, the techniques described herein relate to a method, wherein the wash mode is activated at least in part based on a location of the vehicle.

In some aspects, the techniques described herein relate to a method, wherein, when the vehicle is not in the wash mode, commanding the electronic latch to transition from the latched position to an unlatched position in response to the unlatch signal from the handle switch, when in the wash mode, commanding the electronic latch to maintain the latched position in response to the unlatch signal from the handle switch.

In some aspects, the techniques described herein relate to a vehicle assembly, including: a switch assembly actuatable to provide an unlatch signal; an electronic latch transitionable back-and-forth between a latched position and an unlatched position; and a control module configured to selectively command the electronic latch to transition in response to the unlatch signal, the control module commanding the electronic latch to transition to the unlatched position in response to the unlatch signal when not in a wash mode, the control module configured to maintain the electronic latch in the latched position in response to the unlatch signal when in the wash mode.

In some aspects, the techniques described herein relate to a vehicle assembly, further including a closure module, the electronic latch holding the closure module in a closed position when the electronic latch is in the latched position, the electronic latch permitting movement of the closure module from the closed position to an open position when the electronic latch is in the open position.

In some aspects, the techniques described herein relate to a vehicle assembly, wherein the closure module is a side door.

In some aspects, the techniques described herein relate to a vehicle assembly, further including a handle of the closure module, the switch assembly disposed on the handle.

In some aspects, the techniques described herein relate to a vehicle assembly, wherein the handle includes a first side facing outboard away from the closure module and an opposite, second side facing inboard toward the closure module, the switch assembly disposed on the second side.

In some aspects, the techniques described herein relate to a vehicle assembly, further including a lightbar on the first side of the handle.

In some aspects, the techniques described herein relate to a vehicle assembly, wherein the switch assembly is vertically aligned with a beltline of a vehicle.

In some aspects, the techniques described herein relate to a vehicle assembly, wherein the switch assembly includes a button, a switch, and a printed circuit board.

In some aspects, the techniques described herein relate to a vehicle assembly, wherein the switch assembly includes a plurality of individual switches disposed along a switch axis, the switch axis aligned with a longitudinal axis of the button.

In some aspects, the techniques described herein relate to a vehicle assembly, wherein the switch assembly is disposed on a handle of a closure module, the printed circuit board disposed on an inner surface of the handle of the closure module.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an exemplary vehicle having closure panels and electronic latches.

FIG. 2 illustrates a close-up view of a handle of the vehicle of FIG. 1.

FIG. 3 illustrates a top view of the handle of FIG. 2.

FIG. 4 illustrates a schematic, section view of a switch assembly.

FIG. 5 illustrates a schematic view of a control module for activating a wash mode of the vehicle of FIG. 1 according to an exemplary aspect of the present disclosure.

FIG. 6 illustrates a flow of an exemplary method associated with activating the wash mode.

FIG. 7 illustrates a flow of another exemplary method associated with activating the wash mode.

### DETAILED DESCRIPTION

This disclosure relates generally to blocking a transitioning of an electronic latch when a vehicle is being washed. This can hold a closure module, such as a door, in a closed position when the vehicle is being washed. These and other features are discussed in greater detail in the following paragraphs of this detailed description.

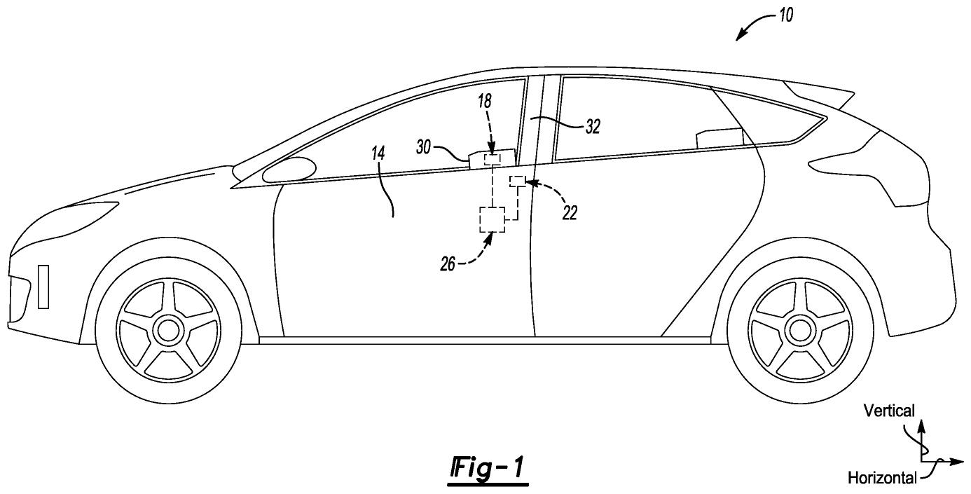

FIG. 1 illustrates a vehicle 10 including a closure module 14, a switch assembly 18, an electronic latch 22, a control module 26, and a handle 30.

In the exemplary embodiment, the vehicle 10 is a car. However, the vehicle 10 could alternatively be a sport utility vehicle (SUV), a van, a pickup truck, or any other vehicle configuration.

The closure module 14 is a front driver side door of the vehicle 10. In other examples, the closure module 14 could be another side door, tailgate, swing gate, trunk, hood, or any other closure configuration.

The electronic latch 22 can transition between a latched position that holds the closure module 14 in a closed position, and an unlatched position that permits movement of the closure module 14 from the closed position and the open position. In this example, the closure module 14 can be pivoted to the open position when the electronic latch 22 is in the unlatched position.

The switch assembly 18 is disposed on the handle 30 in this example. In another example, the switch assembly 18 can be disposed on a pillar 32 of the vehicle 10. The control module 26 is operatively coupled to the switch assembly 18 and the electronic latch 22. In response to an input from the switch assembly 18, the control module 26 can command the electronic latch 22 to transition from the latched position and the unlatched position.

Although a specific component relationship is illustrated in the figures of this disclosure, the illustrations are not intended to limit this disclosure. The placement and orientation of the various components of the vehicle 10 are shown schematically and could vary within the scope of this disclosure.

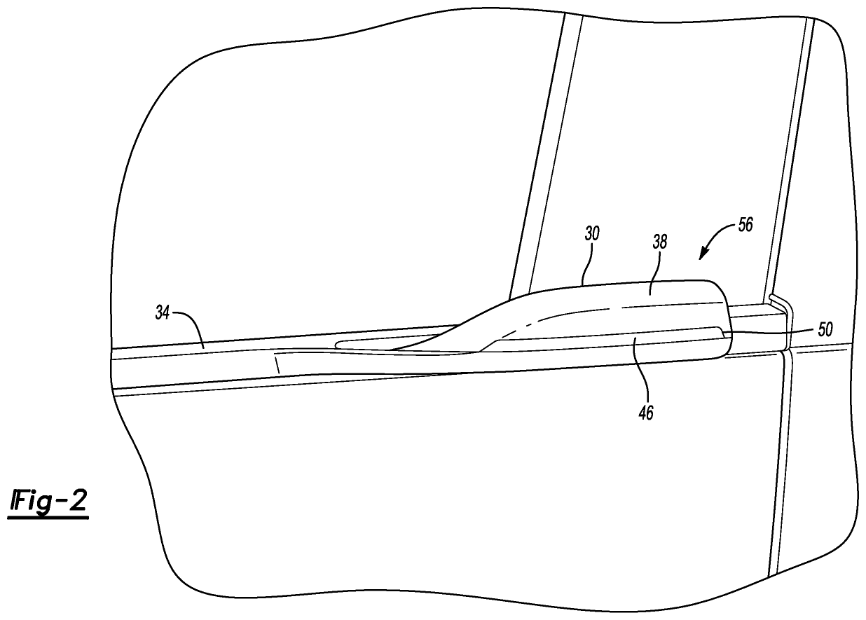

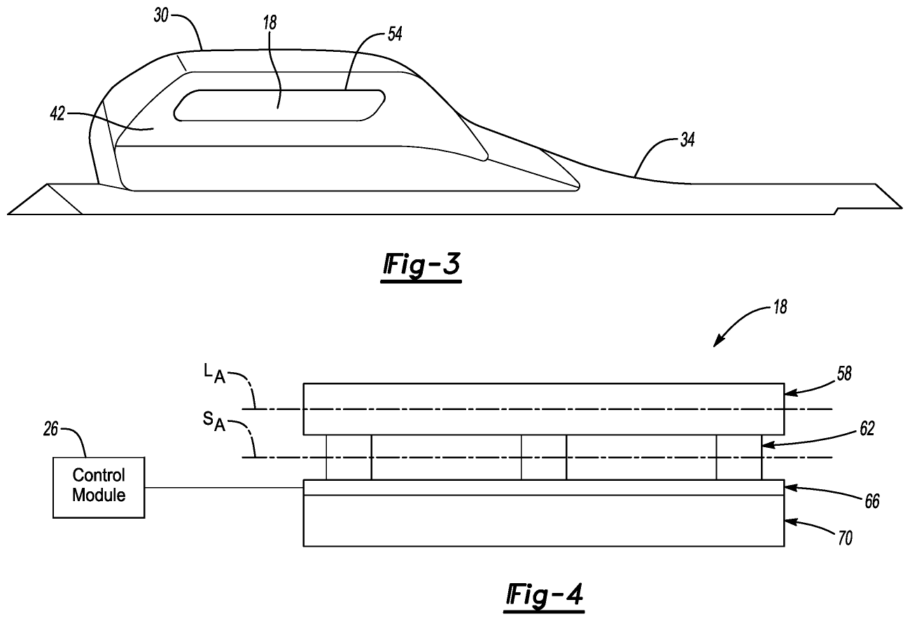

With reference to FIGS. 2 and 3, the handle 30 is disposed at a beltline 34 of the vehicle 10. The handle 30 includes a first side 38 facing outboard and an opposite, second side 42 facing inboard. In the exemplary embodiment, a light bar 46 is disposed within a first opening 50 on the first side 38 of the handle 30, and the switch assembly 18 is disposed within a second opening 54 on the second side 42 of the handle 30.

The light bar 46 provides static and dynamic lighting capabilities to the handle 30 so that a user may locate the handle 30 in low light conditions.

As shown, portions of the handle 30, and thus the switch assembly 18, are spaced outboard to provide an open area 56 between the switch assembly 18 and the beltline 34. A user can reach into the open area 56 to interact with the switch assembly 18 when the user wants to open the closure module 14.

With reference now to FIG. 4 and continuing reference to FIGS. 1-3, the exemplary switch assembly 18 includes a button 58, a plurality of switches 62, and a printed circuit board (PCB) 66.

The button 58 is a capacitive touch-sensitive button in this example. The button 58 is disposed on the plurality of switches 62. When a conductive object, such as a user's finger, touches the button 58, capacitance is established between the button 58 and the plurality of switches 62. When the button 58 is touched, one or more of the plurality of switches 62 can transition causing the PCB 66 to send an unlatch signal to the control module 26.

In the exemplary embodiment, the plurality of switches 62 are distributed along a switch axis SA, which is aligned with a longitudinal axis LA of the button 58. Distributing the switches in this way can enable substantially uniform responsiveness across the longitudinal axis LA of the button 58.

The example PCB 66 is disposed on an inner surface 70 of the handle 30. In an embodiment, the PCB 66 can additionally include one or more lighting devices to provide static and dynamic visual feedback when a user touches the button 58.

In response to the unlatch signal, the control module 26 can command the electronic latch 22 to transition from the latched position to the unlatched position.

The button 58 and switches 62 can be actuated when the vehicle 10 is being washed at, for example, an automatic carwash. Water from the washing could, for example, act as a bridging conductor that triggers the PCB 66 to send the unlatch signal to the control module 26. In addition, brushes used for the wash could enter the open area 56 and contact the button 58 triggering the unlatch signal from the PCB 66. If not prevented, the brushes may pull the handle 30 to pull the closure module 14 open. As can be appreciated, opening the closure module 14 within a carwash is often not desirable. Accordingly, the control module 26 is configured to prevent inadvertent opening of the closure module 14 within a carwash.

As shown in FIG. 5, a controller area network (CAN) bus connects the control module 26 with various components of the vehicle 10. The control module 26 that may include both hardware and software and could be part of an overall vehicle control system, such as a vehicle system controller (VSC), or could alternatively be a stand-alone controller separate from the VSC. In an embodiment, the control module 26 is programmed with executable instructions for interfacing with and commanding operation of the closure module 14, and more particularly the electronic latch 22.

The control module 26 may include a processor and non-transitory memory for executing various control strategies and modes associated with transitioning the electronic latch 22 from a latched position to an unlatched position in response to an unlatch signal from the switch assembly 18, as described above. The processor can be a custom made or commercially available processor, a central processing unit (CPU), or generally any device for executing software instructions. The memory can include any one or combination of volatile memory elements and/or nonvolatile memory elements.

The processor may be operably coupled to the memory and may be configured to execute one or more programs stored in the memory of the control module 26 based on various inputs received from other devices, such as inputs from one or more sensors 74, a Global Positioning System (GPS) 78, a Human-Machine Interface (HMI) 82, etc. In an embodiment, the sensors 74 include a rain sensor, a speed sensor, a transmission position sensor, an ignition sensor, a brake pressure sensor, and a handbrake position sensor.

The control module 26 may receive and process various inputs for activating a wash mode when the vehicle 10 is within the carwash. In an example, the wash mode is active when: (1) an engine of the vehicle 10 is on, (2) brakes of the vehicle 10 are not engaged, (3) the transmission is in Neutral or Park. (4) a speed of the vehicle 10 is zero, and (5) a rain sensor of the vehicle 10 detects water (such as water on the windshield).

When in the wash mode, the control module 26 does not signal the electronic latch 22 to unlatch after the control module 26 receives an unlatch signal from the PCB 66. This prevents the electronic latch 22 from transitioning from the latched position to the unlatched position in response to the unlatch signal from the switch assembly 18. In an embodiment, the wash mode is activated when: (1) a rain sensor of the vehicle 10 detects water (such as water on the windshield), (2) the transmission is in Park or Neutral, (3) the vehicle 10 is moving below a threshold speed, and (4) the brakes of the vehicle 10 are disengaged. In another embodiment, the wash mode is activated in response to user input, which can be provided through a Human-Machine Interface. In another embodiment, the wash mode is activated in response to the vehicle entering a known carwash location.

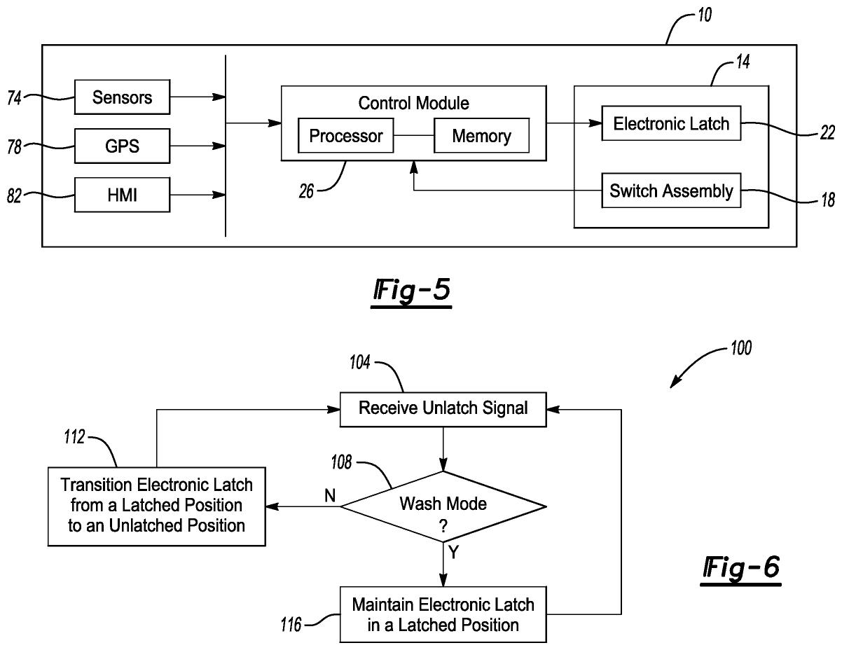

With reference now to FIG. 6 and continued reference to FIG. 5, an exemplary method 100 of selectively activating a wash mode begins at a step 104 where an unlatch signal from the switch assembly 18 is received. The method 100 can be carried out by the control module 26 of the vehicle 10.

After receiving the unlatch signal at the step 104, the method 100 moves to step 108 where the control module 26 assesses whether or not the vehicle 10 is in the wash mode. If not in the wash mode, the method 100 moves to step 112 where the control module 26 transitions the electronic latch 22 from a latched position to an unlatched position to permit pivoting of the closure module 14 from a closed position to an open position. If the vehicle 10 is in the wash mode, the method 100 moves to step 116 where the control module 26 maintains the electronic latch 22 in a latched position to maintain the closure module 14 in a closed position.

Maintaining the electronic latch 22 in the latched position can include preventing the electronic latch 22 from transitioning from the latched position to the unlatched position. Maintaining the electronic latch 22 in the latched position at the step 116 can additionally include locking the closure panel 14 in the closed position. In some examples, an alert could be sent to the user notifying the user that the closure module 14 is being held in the closed position due to the wash mode. The alert can be an audible alert, a visual alert, or both. The alerts can include alerts on a smartphone, alerts on screens of the vehicle, audible chimes or alarms from speakers of the vehicle, from outside the vehicle (using sound exciters), etc. Alerts on a smartphone and/or screens of the vehicle 10 may further explain why the vehicle has activated the wash mode, and, further, may list which closure panel is being maintained in the latched position.

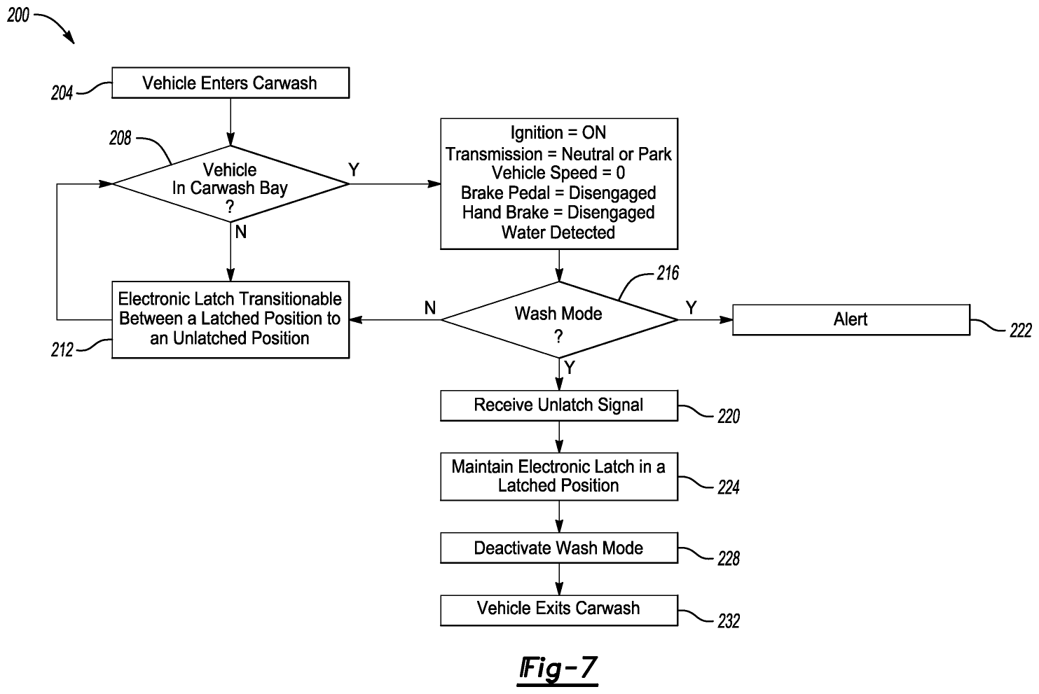

With reference now to FIG. 7 and continued reference to FIG. 5, another exemplary method 200 of selectively activating a wash mode begins at step 204 where a user drives the vehicle 10 into a carwash. Like the method 100, the method 200 can be carried out by the control module 26 of the vehicle 10.

After the vehicle 10 enters the carwash, the method 200 moves to step 208 where the control module 26 assesses whether or not the vehicle 10 has entered a carwash bay. The carwash bay could be an area where the vehicle 10 remains stationary as the vehicle 10 is cleaned or could alternatively be an area where the vehicle 10 moves below a threshold speed along a tunnel during cleaning. If not in the carwash bay, the method 200 moves to step 212 where the control module 26 permits the electronic latch 22 to transition between a latched position and an unlatched position upon receiving an unlatch signal from the switch assembly 18. If the vehicle 10 is in the carwash bay, the method 200 moves to step 216 where the control module 26 assesses whether or not the vehicle 10 has entered a wash mode.

In the exemplary embodiment, the wash mode is activated when: (1) an engine of the vehicle 10 is on, (2) the transmission is in Neutral or Park, (3) a speed of the vehicle 10 is zero, (4) a brake pedal of the vehicle 10 is disengaged, (5) a hand brake of the vehicle 10 is disengaged, and (6) a rain sensor of the vehicle 10 detects water (such as water on the windshield). If not in the wash mode, the method 200 moves to step 212, as described above. If the vehicle 10 in in the wash mode, the method 200 moves to step 220 where an unlatch signal from the switch assembly 18 is received. In the exemplary embodiment, the unlatch signal is triggered in response to an external object, such as a brush and/or water for example, interacting with the switch assembly 18. The method 200 could additionally move to step 222 where the control module 26 sends an alert to a user that the vehicle 10 is in the wash mode. In the exemplary embodiment, the alert could display “Carwash Mode Active” or “Exterior Handle Disabled” on a Human-Machine Interface.

After receiving the unlatch signal at step 220, the method 200 moves to step 224 where the control module 26 maintains the electronic latch 22 in a latched position to maintain the closure module 14 in a closed position. The method 200 then moves to step 228 where the control module 26 deactivates the wash mode. In the exemplary embodiment, the wash mode is deactivated when: (1) an engine of the vehicle 10 is on, (2) the transmission is in Drive or Reverse, and (3) a speed of the vehicle 10 is above zero. The method 200 ends at step 232 where the vehicle 10 exits the carwash.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An electronic latch control method, comprising:
receiving an unlatch signal from at least one handle switch associated with a closure module of a vehicle;
assessing whether the vehicle is in a wash mode; and
when in the wash mode, responding to the unlatch signal by maintaining an electronic latch in a latched position to maintain the closure module in a closed position.

2. The method of claim 1, further comprising when not in the wash mode, responding to the unlatch signal by transitioning the electronic latch from the latched position to an unlatched position to permit pivoting of the closure module from the closed position to an open position.

3. The method of claim 2, where the unlatched position permits the closure module to pivot about an axis.

4. The method of claim 1, wherein the maintaining includes locking the closure module in the closed position.

5. The method of claim 1, wherein the maintaining includes preventing a transitioning of the electronic latch from the latched position to an unlatched position.

6. The method of claim 1, wherein the wash mode is activated when water is detected, a transmission of the vehicle is in park or neutral, a speed of the vehicle is below a threshold speed, and a brake of the vehicle is disengaged.

7. The method of claim 6, wherein water is detected by at least one sensor of the vehicle.

8. The method of claim 1, wherein the wash mode is activated at least in part based on an input from a user.

9. The method of claim 1, wherein the wash mode is activated at least in part based on a location of the vehicle.

10. The method of claim 1, wherein, when the vehicle is not in the wash mode, commanding the electronic latch to transition from the latched position to an unlatched position in response to the unlatch signal from the handle switch, when in the wash mode, commanding the electronic latch to maintain the latched position in response to the unlatch signal from the handle switch.

11. A vehicle assembly, comprising:
a switch assembly actuatable to provide an unlatch signal;
an electronic latch transitionable back-and-forth between a latched position and an unlatched position; and
a control module configured to selectively command the electronic latch to transition in response to the unlatch signal, the control module commanding the electronic latch to transition to the unlatched position in response to the unlatch signal when not in a wash mode, the control module configured to maintain the electronic latch in the latched position in response to the unlatch signal when in the wash mode.

12. The vehicle assembly of claim 11, further comprising a closure module, the electronic latch holding the closure module in a closed position when the electronic latch is in the latched position, the electronic latch permitting movement of the closure module from the closed position to an open position when the electronic latch is in the open position.

13. The vehicle assembly of claim 12, wherein the closure module is a side door.

14. The vehicle assembly of claim 12, further comprising a handle of the closure module, the switch assembly disposed on the handle.

15. The vehicle assembly of claim 14, wherein the handle includes a first side facing outboard away from the closure module and an opposite, second side facing inboard toward the closure module, the switch assembly disposed on the second side.

16. The vehicle assembly of claim 15, further comprising a lightbar on the first side of the handle.

17. The vehicle assembly of claim 11, wherein the switch assembly is vertically aligned with a beltline of a vehicle.

18. The vehicle assembly of claim 11, wherein the switch assembly includes a button, a switch, and a printed circuit board.

19. The vehicle assembly of claim 18, wherein the switch assembly includes a plurality of individual switches disposed along a switch axis, the switch axis aligned with a longitudinal axis of the button.

20. The vehicle assembly of claim 19, wherein the switch assembly is disposed on a handle of a closure module, the printed circuit board disposed on an inner surface of the handle of the closure module.
